(19) United States
(12) Patent Application Publication
(10) Pub. No.: US 2026/0055851 A1
(43) Pub. Date: Feb. 26, 2026

(54) PROCESS TO CAPTURE AND STORE METHANE AND NATURAL GAS FROM PRODUCING FACILITIES USING SOLID SORBENTS

(71) Applicant: Chevron U.S.A. Inc., San Ramon, CA (US)

(72) Inventors: Marcus Vinicius DUTRA e MELLO, Moraga, CA (US); Daniel CHINN, Danville, CA (US); Jennifer M. HERNANDEZ, Midland, TX (US)

(21) Appl. No.: 19/103,771

(22) PCT Filed: Aug. 17, 2023
(86) PCT No.: PCT/US2023/072427

§ 371 Date: Feb. 13, 2025

Related U.S. Application Data
(60) Provisional application No. 63/371,739, filed on Aug. 17, 2022.

(51) Int. Cl. F17C 11/00; E21B 34/16; F17C 5/00; F17C 7/00

(52) U.S. Cl. CPC F17C 11/007; E21B 34/16; F17C 5/002; F17C 7/00; F17C 2221/033; F17C 2223/0123; F17C 2225/0123; F17C 2227/0157; F17C 2227/0302; F17C 2227/048; F17C 2250/0636; F17C 2270/01

(57) ABSTRACT

A process for capturing and storing natural gas from a natural gas production facility includes flowing a natural gas stream through a first natural gas flow path extending from a wellhead to a sales gas pipeline. In response to receiving an indication of a process upset in the sales gas pipeline, at least some of the natural gas stream is diverted from the first natural gas flow path to a second natural gas flow path leading to a storage system having a storage vessel with one or more adsorbent beds such that the natural gas stream diverted to the second natural gas flow path is adsorbed by the one or more adsorbent beds and stored in the storage system.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Methane is a powerful greenhouse gas that may be emitted from certain facilities due to process upsets of normal operations, such as blowdown of process equipment, typically pressure vessels, storage tanks, separators and compressors. Normally, during a process upset emitted natural gas will be flared, which generates carbon dioxide which is also a greenhouse gas. It is presently recognized that reusing the emitted gas and avoiding the formation of carbon dioxide is desirable.

### SUMMARY OF THE INVENTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of this disclosure include a process that allows for continuous storage and release of natural gas in a facility, and is suitable for large scale natural gas facilities. The process generally includes pre-treating, capturing, and storing emitted natural gas in large tanks. These large tanks are filled with sorbent solids that have high affinity for the emitted natural gas and will enhance the storage capacity in comparison with a tank with no sorbents. The released gas can be used in facilities or can be trucked to a pipeline or to another facility.

In one embodiment, the disclosed process uses at least one tank (e.g., vessel), preferably two or more to allow for continuously storing and releasing gas to feed a local user (a furnace or any process equipment that uses natural gas). These tanks may be attached to trucks and be mobile storage facilities that can transport the stored gas to other users or be discharged into a pipeline, in a concept known as “virtual pipeline.” The use of sorbents allows for storage at much lower pressures compared to other technologies such as using compressed natural gas cylinders (e.g., storage at 900 psig or lower vs. storage at 3600 psig for a compressed gas cylinder) and provides a higher storage capacity.

By way of example, in an embodiment, a process for capturing and storing natural gas from a natural gas production facility includes flowing a natural gas stream through a first natural gas flow path extending from a wellhead to a sales gas pipeline. In response to receiving an indication of a process upset in the sales gas pipeline, at least some of the natural gas stream is diverted from the first natural gas flow path to a second natural gas flow path leading to a storage system having a storage vessel with one or more adsorbent beds such that the natural gas stream diverted to the second natural gas flow path is adsorbed by the one or more adsorbent beds and stored in the storage system.

In another embodiment, a system for capturing and storing natural gas from a natural gas production facility includes a storage system having a storage vessel with one or more adsorbent beds configured to reversibly adsorb natural gas. An inlet of the storage system is connected to a first natural gas flow path via a second natural gas flow path that diverges from the first natural gas flow path, wherein the first natural gas flow path extends between a wellhead and a sales gas pipeline and is configured to transport a natural gas stream from the wellhead to the sales gas pipeline. An outlet of the storage system is connected to the first natural gas flow path via a third natural gas flow path that converges with the first natural gas flow path at a position upstream of where the second natural gas flow path diverges from the first natural gas flow path.

### BRIEF DESCRIPTION OF THE DRAWINGS

These and other objects, features and advantages of the present disclosure will become better understood with reference to the following description, appended claims and accompanying drawings, wherein:

FIG. 1 is a schematic diagram of an example system for capturing and storing natural gas from a feed gas using two beds in lead-lag system for continuous capturing and delivery to a pipeline or on-site user, in accordance with an embodiment of this disclosure.

FIG. 2 is a schematic diagram of an example system for capturing, storing, and reintroducing natural gas from a natural gas pipeline using an adsorbent-based storage system, in accordance with an embodiment of this disclosure.

FIG. 3 is a schematic diagram of an example of the adsorbent-based storage system of the system of FIG. 2, in accordance with an embodiment of this disclosure.

FIG. 4 is an example embodiment of the system of FIG. 2 in which the adsorbent-based storage system includes two storage vessels, in accordance with an embodiment of this disclosure.

### DESCRIPTION OF THE INVENTION

In accordance with embodiments of this disclosure, a process uses, by way of example, at least one or two storage tanks (e.g., vessels) filled with a solid sorbent material (e.g., activated carbon, metal organic frameworks, covalent organic frameworks, zeolites etc.) which allows for continuously charging and discharging these storage tanks. In some embodiments, the tanks can operate in a lead-lag regime, i.e., one in adsorption/storage mode and one in desorption/release mode. The use of more than two storage tanks is possible to increase storage capacity for scale-up. Further, it is now recognized that the use of such storage vessels in an appropriate configuration may reduce or altogether eliminate the need to flare natural gas in a natural gas production facility in response to process upsets.

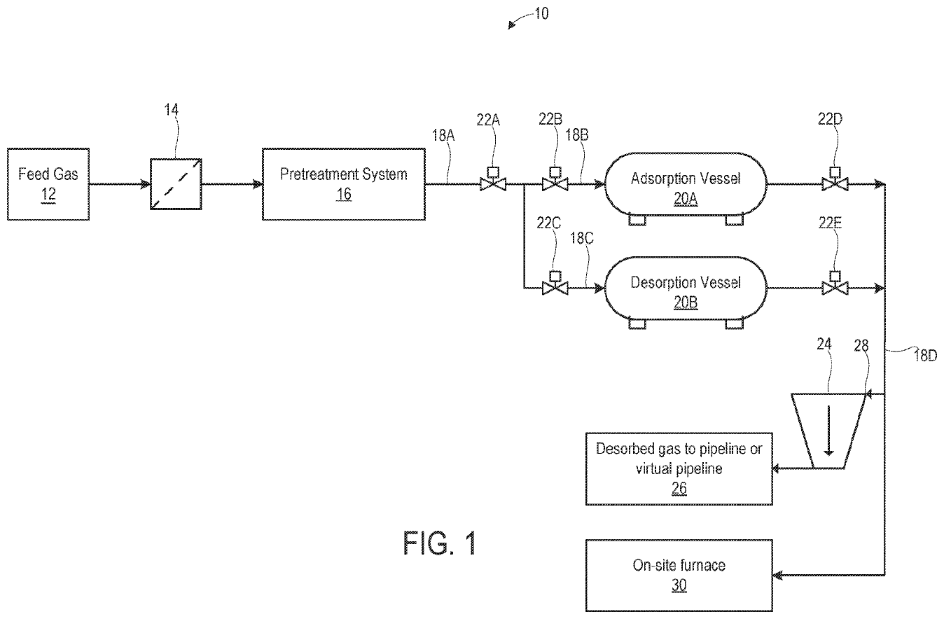

Turning now to the drawings and referring initially to FIG. 1, an embodiment of a system 10 for capturing and storing natural gas is depicted as receiving a feed gas 12, which may be by way of example a stream of natural gas produced by a natural gas facility. The feed gas 12 may be a produced stream of natural gas configured to be delivered to a pipeline or local user, or may be a diverted stream of natural gas, or any combination thereof as described in further detail below.

Depending on the source of the feed gas 12 released during normal and abnormal operations in the natural gas facility, filtering using a filter system 14 and pretreatment using a pretreatment system 16 may be needed. The filter system 14 may include one or more filters configured to remove particulate matter such as sand from the feed gas 12. The pretreatment system 16 may include, for example, a heat exchanger for dewpointing control, acid gas removal apparatus such as beds, membranes, or other vessels for removing acid gases (H₂S and CO₂), a dehydration assembly (e.g., a guard bed), and optionally one or more pumps or compressors to control the pressure of the feed gas 12. The filter system 14 and the pretreatment system 16 may be configured to generate a treated natural gas from the feed gas 12 (for a certain specification suitable for use as a sales gas, or other value-added stream.

The depicted system 10 also includes a series of flow paths 18 configured to carry the treated natural gas to one or more adsorption vessels 20. As shown, the flow paths 18 include a primary flow path 18A, which is split into an adsorption flow path 18B and a desorption flow path 18C leading to an adsorption vessel 20A and a desorption vessel 20B, respectively. The adsorption vessels 20 may include any one or a combination of adsorbent materials configured to reversibly adsorb methane at the temperatures and pressures at which the system 10 may operate, as described in further detail below. By way of non-limiting example, the adsorbent materials of the adsorption vessels 20 may be selected from the group consisting of activated carbon, metal organic frameworks, covalent organic frameworks, and zeolites.

The treated natural gas (from the pretreatment system 16) may be split between the adsorption and desorption flow paths using a series of flow control devices 22 (e.g., valves such as powered valves), including a first flow control device 22A that prevents back fill of the main flow path 18A, a second flow control device 22B that controls flow to the adsorption vessel 20A, and a third flow control device 22C that controls flow to the desorption vessel 20B.

The adsorption vessels 20 are referred to as being an adsorption vessel and a desorption vessel to denote that they may operate in this mode, where one vessel is operated in adsorption mode to capture and store natural gas, while the other vessel is operated in desorption mode to desorb and release natural gas. The mode of operation of these vessels may be controlled based on, for instance, their controlled internal temperature and a pressure to which the vessel is subjected. For instance, the adsorption vessel 20A may operate in adsorption mode at a first temperature and pressure, but may be transitioned to a desorption mode by increasing its internal temperature and decreasing its internal pressure. Similarly, the desorption vessel 20B may operate in desorption mode at a second temperature (higher than the first temperature) and a second pressure (lower than the first temperature), but may be transitioned to an adsorption mode by decreasing its internal temperature and increasing its internal pressure. The degree of temperature and pressure changes required to transition the vessels between adsorption and desorption mode may depend on, for instance, the nature and amount of adsorbent material or materials used and the internal temperature and pressure at which the vessels are otherwise designed to hold the natural gas.

The vessels 20 are generally equipped with additional features such as a heating pad to facilitate and enhance gas release during the discharging operations and internal gas network pipes to allow for better gas distribution throughout the whole tank volume (internal vessel volume) during loading. These vessels can range in volume. One example is a 10,000 gallon tank.

A fourth flow control device 22D and a fifth flow control device 22E control the flow out of the adsorption vessel 20A and the desorption vessel 20B, respectively, into a downstream flow path 18D configured to deliver desorbed natural gas to a variety of users. As illustrated, the downstream flow path 18D is fluidly coupled with a compressor 24 configured to compress the desorbed gas to a pressure appropriate for delivery to a pipeline or virtual pipeline 26. An intake 28 of the compressor 24 may be operated to close or open the compressor 24 to the downstream flow path 18D and in this way, may control an amount of the desorbed natural gas delivered to a local user (e.g., gas driven equipment), such as an on-site furnace 30.

The configuration described with respect to FIG. 1 may be used alone or in combination with other arrangements, such as arrangements specifically configured to handle process upsets that would typically result in the flaring of natural gas. Indeed, using the embodiments described herein, it may be possible to reduce or altogether eliminate flaring in a natural gas production facility.

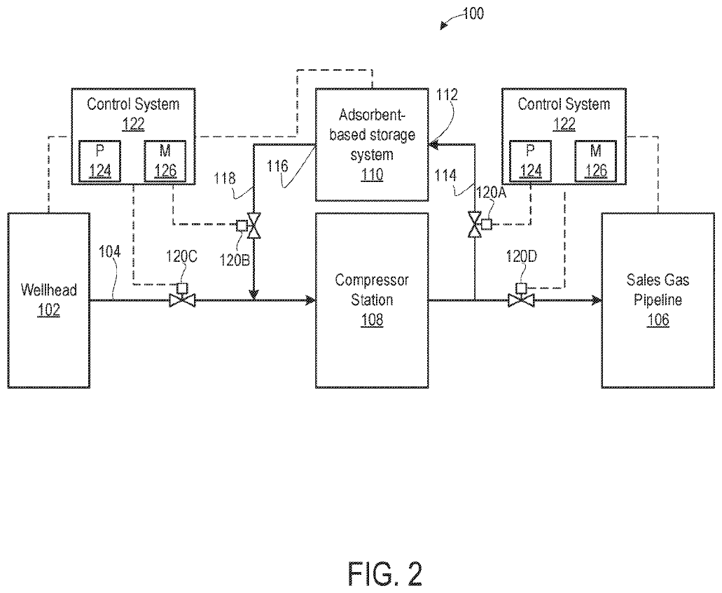

One embodiment of a capture and storage system 100 configured to capture and store natural gas in a natural gas production facility to reduce or eliminate flaring is depicted in FIG. 2. The illustrated embodiment includes basic features of a natural gas production facility including a wellhead 102 from which a stream of produced natural gas is received into a main natural gas flow path 106 (e.g., a first flow path) connecting the wellhead 102 with a sales gas pipeline 106 (or other downstream process) (or another downstream use such as a gas lift process). The main natural gas flow path 106 may include other features not specifically shown, such as any one or a combination of the elements of system 10 in FIG. 1, and is generally configured to transport the natural gas stream from the wellhead 102 to the sales gas pipeline 106 (or other downstream process).

The produced natural gas from the wellhead 102 may require compression to a pressure appropriate for introduction into the sales gas pipeline 106 (or other downstream process), and accordingly the main flow path 104 may include a compressor station 108 including at least one compressor configured to compress the natural gas from a first pressure to a second, higher pressure suitable for the sales gas pipeline 106 (or other downstream process). In a typical natural gas production facility, when process upsets occur in the sales gas pipeline 106 (or other downstream process) (or process upsets in another downstream use), the natural gas is flared (combusted) in a flare system rather than delivered to a useful process or a commodity pipeline. Such flaring not only wastes the natural gas produced but also generates CO₂ and other combustion byproducts.

To reduce or eliminate such flaring, in accordance with present embodiments the system 100 includes an adsorbent-based storage system 110 configured to capture and store the produced natural gas for later use (e.g., later reintroduction into the main natural gas flow path 104). In the illustrated embodiment, an inlet 112 of the adsorbent-based storage system 110 is connected to the main natural gas flow path 104 via a divergent natural gas flow path 114 (e.g., a second natural gas flow path) that diverges from the main natural gas flow path 104. The divergent natural gas flow path 114 is configured to divert a compressed natural gas stream generated at the compressor station 108 from the main flow path 104 and to the adsorbent-based storage system 110.

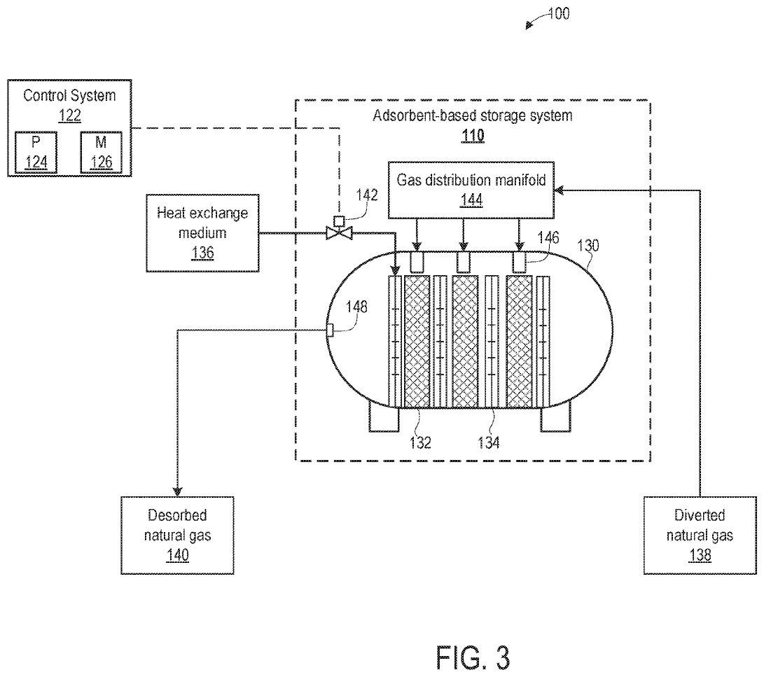

An outlet 116 of the adsorbent-based storage system 110 is connected to the main natural gas flow path 104 via a convergent flow path 118 (e.g., a third natural gas flow path) configured to deliver natural gas that is desorbed from the adsorbent-based storage system 110 to the main natural gas flow path 104. Further details regarding the adsorbent-based storage system 110 are described with respect to FIG. 3.

The relative positioning of the divergent natural gas flow path 114 and the convergent natural gas flow path 118 is selected to reduce the energy requirements for natural gas capture, storage, and release and thus enhance the efficiency of the overall natural gas facility. For example, the divergent natural gas flow path 114 diverges from the main natural gas flow path 104 at a location downstream of the compressor station 108 such that the compressed natural gas is at a pressure that motivates the natural gas toward the adsorbent-based storage system 110 and encourages adsorption within the adsorbent-based storage system 110. In one non-limiting embodiment, the divergent natural gas flow path 114 diverges from the outlet of the compressor station 108 (e.g., an outlet plenum of a compressor).

On the other hand, the convergent natural gas flow path 118 converges with the main natural gas flow path 104 at a location upstream of the compressor station 108, which means that when the compressor station 108 is operated, the pressure drop from the adsorbent-based storage system 110 to the compressor station 108 encourages natural gas desorption from the adsorbent-based storage system 110 and motivates the desorbed natural gas from the adsorbent-based storage system 110 toward the main natural gas flow path 104. In one non-limiting embodiment, the convergent natural gas flow path 118 converges at the intake of the compressor station 108 (e.g., an intake plenum of a compressor).

The system 100 includes a plurality of flow control devices 120, such as flow control valves (which may also act as flow diverters based on their positioning and coordination) to control the flow of the natural gas through the main natural gas flow path 104, the divergent natural gas flow path 114, and the convergent natural gas flow path 118. In the illustrated embodiment, a first flow control valve 120A (e.g., a flow diversion apparatus) is positioned and configured to controllably divert at least some of the natural gas stream from the main natural gas flow path 104 and to the divergent natural gas flow path 114. A second flow control valve 120B (e.g., a flow introduction apparatus) is positioned and configured to controllably introduce a natural gas stream released from the adsorbent-based storage system 110 (e.g., desorbed natural gas) into the main natural gas flow path 104 via the convergent natural gas flow path 118.

A third flow control valve 120C is positioned between a location at which the convergent natural gas flow path 118 meets the main natural gas flow path 104 and the wellhead 102. The third flow control valve 120C thus may be controlled to adjust flow from the wellhead 102 through the main natural gas flow path 104 and to block natural gas from flowing from the adsorbent-based storage system 110 back toward the wellhead 102.

A fourth flow control valve 120D is positioned along the main natural gas flow path 104 at a location downstream of the point at which the divergent natural gas flow path 114 diverges from the main natural gas flow path 104. The fourth flow control valve 120D thus may be controlled to block natural gas flow toward the sales gas pipeline 106 (or other downstream process) from the compressor station 108.

The flow control valves 120 may be of any appropriate type and may or may not include actuators to facilitate automated operation. In some embodiments, operation of the flow control valves 120, among other features of the system 100, may be controlled by a control system 122 in response to one or more monitored parameters of the sales gas pipeline 106 (or other downstream process), the adsorbent-based storage system 110, the wellhead 102, or any combination thereof. In particular, the control system 122 may be communicatively coupled to the flow control devices 120 of the system 100 as well as various sensors associated with the wellhead 102, the adsorbent-based storage system 110, sales and the gas pipeline 106. Additionally or alternatively, the control system 122 may utilize one or more user interface devices (not shown) to alert a user to certain conditions, and to allow for user inputs and monitoring.

While shown as blocks in FIG. 2, in an actual implementation the control system 122 may include one or more control devices, which may be the same or different. For example, the control system 122 may include one or more programmable logic controllers, distributed control system devices, computing devices, and so forth. In this way, a processor 124 and a memory 126 of the control system 122 are described herein to generally denote processing devices and memory devices that may be single units or a plurality of units which may be distributed amongst a variety of devices.

The processor 124 can be any of a variety of types of programmable circuits capable of executing computer-readable instructions to perform various tasks, such as modeling, calculation, and communication tasks. The memory 126 can include any of a variety of memory devices, such as devices using various types of computer-readable or computer storage media. A computer storage medium or computer-readable medium may be any medium that can contain or store the program for use by or in connection with the instruction execution system, apparatus, or device. In example embodiments, the computer storage medium is embodied as a computer storage device, such as a memory or mass storage device. In particular embodiments, the computer-readable media and computer storage media of the present disclosure include at least some tangible devices, and in specific embodiments such computer-readable media and computer storage media include exclusively non-transitory media. Again, generally, the processor 124 and memory 126 allow the control system 122 to perform various monitoring and control tasks relating to the operation of the adsorbent-based storage system 110 and the flow of produced natural gas through the system 100.

The control system 122 may be responsible for controlling the performance of a process for capturing and storing natural gas in the natural gas production facility. For example, in some embodiments, the control system 122 may perform a process that includes flowing the natural gas stream through the main natural gas flow path 104 and, in response to receiving an indication of a process upset in the sales gas pipeline 106 (or other downstream process), diverting at least some of the natural gas stream from the main natural gas flow path 104 to the divergent natural gas flow path 114 leading to the adsorbent-based storage system 110. Further, in embodiments where the system 100 includes a flare system, the control system 122 may determine how much, if any, of the natural gas stream to divide between the adsorbent-based storage system 110 and the flare. In some embodiments, all the flow of the natural gas is sent to the adsorbent-based storage system 110 and no natural gas is sent to the flare. For example, the control system 122 may move the first flow control valve 120A from a normally closed position to an open position, and may move the fourth flow control valve 120D from a normally open position to a partially or fully closed position. Indeed, diverting the natural gas stream from the main natural gas flow path 104 may include completely shutting off flow of the natural gas stream to the sales gas pipeline 106 (or other downstream process) by completely shutting the fourth flow control valve 120D. These operations, in some embodiments, may be done while also shutting natural gas flow from the wellhead 102 to the compressor station 108 by moving the third flow control valve 120C from a normally open to a partially or fully closed position (e.g., in response to receiving an indication that the adsorbent-based storage system 110 is storing at capacity).

The control system 122 may also, in some embodiments, perform certain control functions to cause process steps to occur in response to receiving indications relating to normal operation of the sales gas pipeline 106 (or other downstream process) (or, more generally in response to the one or more input signals indicating an operating regime of the sales gas pipeline 106 (or other downstream process) that is acceptable for receiving natural gas). By way of example, in response to receiving an indication that the sales gas pipeline 106 (or other downstream process) is operating under normal operating conditions (or, more generally in response to the one or more input signals indicating an operating regime of the sales gas pipeline 106 (or other downstream process) that is acceptable for receiving natural gas), the control system 122 may initiate a process that causes natural gas to be desorbed from adsorbent in the storage system 110. Such a process may also include releasing a desorbed natural gas stream from the adsorbent-based storage system 110 into the convergent natural gas flow path 118. Indeed, the control system 122 may open the convergent natural gas flow path 118 to the compressor station inlet causing a drop in pressure, thereby encouraging natural gas desorption from the adsorbent-based storage system 110. This may be done in concert with other processes, such as engaging heating or cooling features of the adsorbent-based storage system 110 as described in further detail with respect to FIG. 3.

FIG. 3 is a schematic view showing more details of the adsorbent-based storage system 110. As illustrated, the adsorbent-based storage system 110 includes at least one storage vessel 130, which houses one or more adsorbent beds 132 configured to reversibly adsorb natural gas. The one or more adsorbent beds 132 may generally include solid sorbent materials on a support. In some embodiments, the solid sorbent materials may be selected from the group consisting of activated carbon, metal organic frameworks, covalent organic frameworks, and zeolites.

The illustrated embodiment of the storage vessel 130 also includes one or more heat exchangers 134 configured to control an internal temperature of the storage vessel 130 to facilitate the storage or release of natural gas from the solid sorbent material. The one or more heat exchangers 134 may be positioned internally and/or externally relative to the storage vessel 130, and may include by way of example a heating unit and/or a cooling unit. By way of non-limiting example, the one or more heat exchangers 134 may include an internal pipeline manifold, tube heat exchangers, finned tube heat exchangers, shell and tube heat exchangers, or any other appropriate heat exchanger configuration. Additionally or alternatively, the one or more heat exchangers may include a heat pad, a cooling pad, or combination thereof positioned about the storage vessel 130.

The one or more heat exchangers 134 may be configured to receive a heat exchange medium 136 from a heat exchange medium source. By way of example, the heat exchange medium 136 may include cooling water, heating water, heating steam, and so forth.

As set forth above, the control system 122 may perform various control processes to facilitate uptake of a stream of diverted natural gas 138 (natural gas diverted from the main natural gas flow path 104 of FIG. 2) in the storage vessel 130, and/or to facilitate desorption and release of a stream of desorbed natural gas 140 from the storage vessel 130. By way of example, the control system 122 may control the opening and closing of a heat exchange flow control valve 142 to control flow of the heat exchange medium 136 to controllably heat or cool the storage vessel 130 to an appropriate temperature. Generally, heating the storage vessel 130 may encourage desorption of the natural gas from the one or more adsorbent beds 132, while cooling the storage vessel 130 may encourage adsorption of the natural gas by the one or more adsorbent beds 132. The rate, volume, etc. of the flow of the heat exchange medium 136, controlled via the heat exchange flow control valve 142, thus controls the amount of heating and/or cooling.

In some embodiments, the adsorbent-based storage system 110 may include heat exchange features to cool the diverted natural gas 138 before delivery to the storage vessel 130, or upon delivery to the storage vessel 130, to facilitate adsorption by the one or more adsorbent beds 132. The control system 122 may also heat or cool the storage vessel 130 in response to ambient conditions. For instance, if the ambient temperature surrounding the storage vessel is relatively high (e.g., a hot day), the control system 122 may initiate cooling of the storage vessel and initiate heating on a day where the ambient temperature surrounding the vessel is relatively low (e.g., a cold day) to ensure that the storage vessel 130 is able to store natural gas at an appropriate level.

For example and as set forth above, the storage vessel 130 is configured to receive the diverted natural gas 138 from the divergent natural gas flow path 114, and the diverted natural gas 138 may be a compressed natural gas generated at the compressor station 108. In some embodiments, the storage vessel 130 may be configured to store natural gas at a storage pressure that is within a certain range of a pressure to which the compressor station 108 is configured to compress the natural gas. By way of non-limiting example, the storage vessel 130 may be configured to store the natural gas at a storage pressure that is within between 60% and 95%, such as between 70% and 90%, such as within 80% of a pressure to which the compressor station 108 is configured to compress the natural gas.

It should also be noted that the use of sorbents allows for storage at much lower pressures compared to other technologies such as using compressed natural gas cylinders (e.g., storage at 900 psig or lower vs. storage at 3600 psig for a compressed gas cylinder) and provides a higher storage capacity. Indeed, the presently disclosed storage vessels 130 may be configured to store natural gas at a pressure of between 100 psig and 2000 psig, more particularly between 200 psig and 1500 psig, and even more particularly between 400 psig and 1000 psig.

As illustrated, in some embodiments a gas distribution manifold 144 may be used to encourage even distribution of the diverted natural gas 138 through the storage vessel 130 and thereby enhance natural gas adsorption. For instance, the gas distribution manifold 144 may introduce the diverted natural gas 138 via one or more nozzles or tubes 146 distributed at different locations within the storage vessel 130.

The storage vessel 130 as illustrated also includes at least one outlet 148 configured to allow the desorbed natural gas 140 to exit via, for example, the convergent natural gas flow path 118 of FIG. 2. Again, the convergent natural gas flow path 118 is fluidly connected to the main natural gas flow path 104 upstream of the compressor station 108 and thus may facilitate the desorption process by reducing pressure within the storage vessel 130 when the second flow control valve 120B is opened.

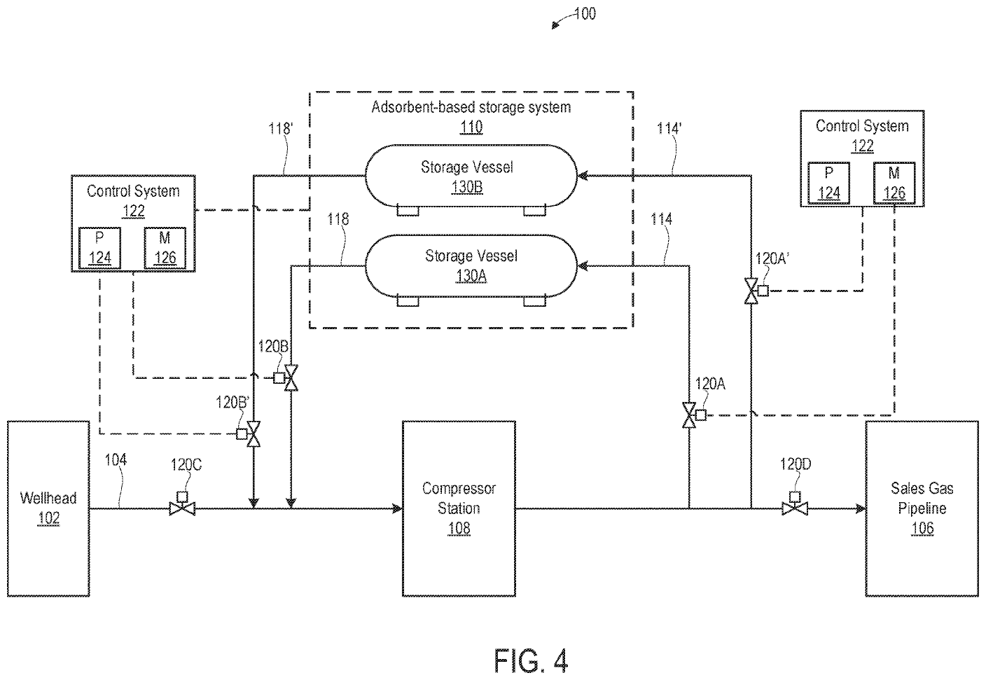

In some embodiments, the adsorbent-based storage system 110 includes more than one storage vessel, as shown in FIG. 4. More particularly, the embodiment of FIG. 4 includes a similar configuration to that shown in FIG. 2, but with multiple storage vessels (130A and 130 B) of the adsorbent-based system 110 each being configured to receive a respective diverted natural gas (e.g., diverted natural gas 138 of FIG. 3) via a respective divergent natural gas path (114 and 114′). Each of the storage vessels of FIG. 4 may be considered to have the configuration described with respect to FIG. 3.

In a similar manner as described above with respect to FIG. 2, in response to receiving input signals relating to a process upset associated with the sales gas pipeline 106 (or other downstream process), the control system 122 may initiate diversion of the natural gas stream from the main natural gas flow path 104 and toward the adsorbent-based storage system 110. The control system 122 may open, for example, either or both of the first flow control valves 120A or 120A′, depending on whether a first storage vessel 130A and a second storage vessel 130B are operating in adsorption or desorption mode. Indeed, in some embodiments, the first and second storage vessels 130A and 130B may operate in a lead-lag regime where one storage vessel is adsorbing while the other is desorbing, or where one is at full capacity and thus closed to flow while the other continues to fill.

For instance, in embodiments where both are operating in adsorption mode, the control system 122 may open both first flow control valves 120A and 120A′ while closing valve 120D to divert the natural gas stream into both the first storage vessel 130A and the second storage vessel 130B in response to input signals indicating the above-mentioned process upset. Conversely, if for example only the second storage vessel 130B is operating in adsorption mode, the control system 122 may open the first flow control valve 120A′ while maintaining the first flow control valve 120A in a closed position in response to input signals indicating the above-mentioned process upset.

The illustrated system 100 also includes respective convergent flow paths 118 and 118′ for the first and second storage vessels 130A and 130B, along with respective flow control valves 120B and 120B′ to allow for flow control of desorbed natural gas (e.g., desorbed natural gas 140 of FIG. 3) toward the main natural gas flow path 104. In embodiments where both the first and second storage vessels 130A and 130B are operating in desorption mode, the control system 122 may open both the second flow control valves 120B and 120B′ while closing the third flow control valve 120C in response to input signals indicating that the sales gas pipeline 106 or other downstream process is operating in a manner suitable for receiving natural gas. Conversely, if for example only the second storage vessel 130B is operating in desorption mode, the control system 122 may open the second flow control valve 120B′ while maintaining the second flow control valve 120B in a closed position in response to input signals indicating the above-mentioned operation.

### ADDITIONAL DESCRIPTION

The following clauses are offered as a further description of embodiments of the invention as illustrated in the drawings. These embodiments may be used alone or in any appropriate combination.
Embodiment 1. A process for capturing and storing natural gas from a natural gas production facility, the process comprising: flowing a natural gas stream through a first natural gas flow path extending from a wellhead to a sales gas pipeline; and in response to receiving an indication of a process upset in the sales gas pipeline, diverting at least some of the natural gas stream from the first natural gas flow path to a second natural gas flow path leading to a storage system comprising a storage vessel having one or more adsorbent beds such that the natural gas stream diverted to the second natural gas flow path is adsorbed by the one or more adsorbent beds and stored in the storage system.
Embodiment 2. The process of embodiment 1, wherein diverting at least some of the natural gas stream from the first natural gas flow path comprises diverting the natural gas stream from the first natural gas flow path at a position downstream of a compressor station positioned along the first natural gas flow path between the wellhead and the sales gas pipeline such that the diverted natural gas stream is a compressed natural gas stream.
Embodiment 3. The process of any preceding embodiment, wherein diverting at least some of the natural gas stream from the first natural gas flow path comprises completely shutting off flow of the natural gas stream to the sales gas pipeline.
Embodiment 4. The process of any preceding embodiment, wherein diverting at least some of the natural gas stream to the storage system is performed in lieu of sending any of the natural gas stream to a flare of the gas production facility.
Embodiment 5. The process of any preceding embodiment, comprising, in response to receiving an indication that the sales gas pipeline is operating under normal operating conditions: desorbing natural gas from the one or more adsorbent beds of the storage vessel, or desorbing natural gas from another one or more adsorbent beds of another storage vessel; and releasing a desorbed natural gas stream from the storage system into a third natural gas flow path extending from the storage system to the first natural gas flow path.
Embodiment 6. The process of any preceding embodiment, wherein the third natural gas flow path meets the first natural gas flow path at a position upstream of the compressor station such that operation of the compressor station motivates the desorbed natural gas through the third natural gas flow path.
Embodiment 7. The process of any preceding embodiment, wherein the third natural gas flow path meets the first natural gas flow path at an inlet of the compressor station.
Embodiment 8. The process of any preceding embodiment, wherein the storage system comprises the storage vessel and the another storage vessel operating in a lead-lag arrangement in which the storage vessel is in adsorption mode and the another storage vessel is in desorption mode, such that the storage vessel uptakes the compressed natural gas stream and the another storage vessel releases the desorbed natural gas.
Embodiment 9. The process of any preceding embodiment, wherein the storage vessel and the another storage vessel are configured as mobile storage locations and are capable of being readily attached and detached from their respective flow paths.
Embodiment 10. The process of any preceding embodiment, wherein diverting at least some of the natural gas stream from the first natural gas flow path to the second natural gas flow path comprises using a flow diversion apparatus to controllably divert at least some of the natural gas stream from the first natural gas flow path and to the second natural gas flow path, wherein the flow diversion apparatus is controlled by a control system comprising non-transitory, machine-readable media storing instructions configured to control the flow diversion apparatus based at least in part on one or more first input signals relating to the operation of the sales gas pipeline.
Embodiment 11. The process of any preceding embodiment, comprising heating the another vessel using a heating unit to facilitate desorption of the natural gas from the another one or more adsorbent beds, wherein the control unit controls operation of the heating unit in response to one or more second input signals relating to the operation of the sales gas pipeline.
Embodiment 12. A system for capturing and storing natural gas from a natural gas production facility, the system comprising: a storage system comprising a storage vessel having one or more adsorbent beds configured to reversibly adsorb natural gas; an inlet of the storage system connected to a first natural gas flow path via a second natural gas flow path that diverges from the first natural gas flow path, wherein the first natural gas flow path extends between a wellhead and a sales gas pipeline and is configured to transport a natural gas stream from the wellhead to the sales gas pipeline; and an outlet of the storage system connected to the first natural gas flow path via a third natural gas flow path that converges with the first natural gas flow path at a position upstream of where the second natural gas flow path diverges from the first natural gas flow path.
Embodiment 13. The system of any preceding embodiment, wherein the second natural gas flow path diverges from the first natural gas flow path at a position downstream from a compressor station positioned along the first natural gas flow path, and wherein the third natural gas flow path converges with the first natural gas flow path at a position upstream of the compressor station.
Embodiment 14. The system of any preceding embodiment, wherein the storage vessel is configured to store the natural gas at a storage pressure that is within 80% of a pressure to which the compressor station is configured to compress the natural gas.
Embodiment 15. The system of any preceding embodiment, comprising: a flow diversion apparatus positioned and configured to controllably divert at least some of the natural gas stream from the first natural gas flow path and to the second natural gas flow path; and a flow introduction apparatus positioned and configured to controllably introduce a natural gas stream released from the storage system into the first natural gas flow path.
Embodiment 16. The system of any preceding embodiment, comprising a control system connected to the flow diversion apparatus and the flow introduction apparatus, the control system comprising non-transitory, machine-readable media storing instructions configured to control the flow diversion apparatus and the flow introduction apparatus in response to one or more input signals relating to the operation of the sales gas pipeline.
Embodiment 17. The system of any preceding embodiment, wherein the control system is configured to divert, using the flow diversion apparatus, at least some of the natural gas stream from the first natural gas flow path into the second natural gas flow path in response to the one or more input signals indicating a process upset in the sales gas pipeline.
Embodiment 18. The system of any preceding embodiment, wherein the control system is configured to introduce, using the flow introduction apparatus, a desorbed natural gas stream from the storage system into the first natural gas flow path from the third natural gas flow path in response to the one or more input signals indicating an operating regime of the sales gas pipeline that is acceptable for receiving natural gas.
Embodiment 19. The system of any preceding embodiment, wherein the storage system comprises an additional storage vessel having an additional one or more adsorbent beds configured to reversibly adsorb natural gas, and wherein the storage vessel is coupled to the inlet of the storage system while the additional storage vessel is coupled to the outlet of the storage system such that the storage vessel is configured to receive diverted natural gas from the second natural gas flow path and the additional storage vessel is configured to release desorbed natural gas into the third natural gas flow path.
Embodiment 20. The system of any preceding embodiment, comprising a heating unit communicatively coupled to the control unit and configured to heat the additional storage vessel in response to control signals from the control unit, and wherein the control unit is configured to heat the additional storage vessel to facilitate desorption of natural gas from the additional one or more adsorbent beds in response to the one or more input signals indicating the operating regime of the sales gas pipeline that is acceptable for receiving natural gas.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

This written description uses examples to disclose the invention, including the best mode, and to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

From the above description, those skilled in the art will perceive improvements, changes and modifications, which are intended to be covered by the appended claims.

1. A process for capturing and storing natural gas from a natural gas production facility, the process comprising:
flowing a natural gas stream through a first natural gas flow path extending from a wellhead to a sales gas pipeline; and
in response to receiving an indication of a process upset in the sales gas pipeline, diverting at least some of the natural gas stream from the first natural gas flow path to a second natural gas flow path leading to a storage system comprising a storage vessel having one or more adsorbent beds such that the natural gas stream diverted to the second natural gas flow path is adsorbed by the one or more adsorbent beds and stored in the storage system.

2. The process of claim 1, wherein diverting at least some of the natural gas stream from the first natural gas flow path comprises diverting the natural gas stream from the first natural gas flow path at a position downstream of a compressor station positioned along the first natural gas flow path between the wellhead and the sales gas pipeline such that the diverted natural gas stream is a compressed natural gas stream.

3. The process of claim 2, wherein diverting at least some of the natural gas stream from the first natural gas flow path comprises completely shutting off flow of the natural gas stream to the sales gas pipeline.

4. The process of claim 3, wherein diverting at least some of the natural gas stream to the storage system is performed in lieu of sending any of the natural gas stream to a flare of the gas production facility.

5. The process of claim 2, comprising, in response to receiving an indication that the sales gas pipeline is operating under normal operating conditions:
desorbing natural gas from the one or more adsorbent beds of the storage vessel, or desorbing natural gas from another one or more adsorbent beds of another storage vessel; and
releasing a desorbed natural gas stream from the storage system into a third natural gas flow path extending from the storage system to the first natural gas flow path.

6. The process of claim 5, wherein the third natural gas flow path meets the first natural gas flow path at a position upstream of the compressor station such that operation of the compressor station motivates the desorbed natural gas through the third natural gas flow path.

7. The process of claim 6, wherein the third natural gas flow path meets the first natural gas flow path at an inlet of the compressor station.

8. The process of claim 5, wherein the storage system comprises the storage vessel and the another storage vessel operating in a lead-lag arrangement in which the storage vessel is in adsorption mode and the another storage vessel is in desorption mode, such that the storage vessel uptakes the compressed natural gas stream and the another storage vessel releases the desorbed natural gas.

9. The process of claim 8, wherein the storage vessel and the another storage vessel are configured as mobile storage locations and are capable of being readily attached and detached from their respective flow paths.

10. The process of claim 8, wherein diverting at least some of the natural gas stream from the first natural gas flow path to the second natural gas flow path comprises using a flow diversion apparatus to controllably divert at least some of the natural gas stream from the first natural gas flow path and to the second natural gas flow path, wherein the flow diversion apparatus is controlled by a control system comprising non-transitory, machine-readable media storing instructions configured to control the flow diversion apparatus based at least in part on one or more first input signals relating to the operation of the sales gas pipeline.

11. The process of claim 10, comprising heating the another vessel using a heating unit to facilitate desorption of the natural gas from the another one or more adsorbent beds, wherein the control unit controls operation of the heating unit in response to one or more second input signals relating to the operation of the sales gas pipeline.

12. A system for capturing and storing natural gas from a natural gas production facility, the system comprising:
a storage system comprising a storage vessel having one or more adsorbent beds configured to reversibly adsorb natural gas;
an inlet of the storage system connected to a first natural gas flow path via a second natural gas flow path that diverges from the first natural gas flow path, wherein the first natural gas flow path extends between a wellhead and a sales gas pipeline and is configured to transport a natural gas stream from the wellhead to the sales gas pipeline; and
an outlet of the storage system connected to the first natural gas flow path via a third natural gas flow path that converges with the first natural gas flow path at a position upstream of where the second natural gas flow path diverges from the first natural gas flow path.

13. The system of claim 12, wherein the second natural gas flow path diverges from the first natural gas flow path at a position downstream from a compressor station positioned along the first natural gas flow path, and wherein the third natural gas flow path converges with the first natural gas flow path at a position upstream of the compressor station.

14. The system of claim 13, wherein the storage vessel is configured to store the natural gas at a storage pressure that is within 80% of a pressure to which the compressor station is configured to compress the natural gas.

15. The system of claim 12, comprising:
a flow diversion apparatus positioned and configured to controllably divert at least some of the natural gas stream from the first natural gas flow path and to the second natural gas flow path; and
a flow introduction apparatus positioned and configured to controllably introduce a natural gas stream released from the storage system into the first natural gas flow path.

16. The system of claim 15, comprising a control system connected to the flow diversion apparatus and the flow introduction apparatus, the control system comprising non-transitory, machine-readable media storing instructions configured to control the flow diversion apparatus and the flow introduction apparatus in response to one or more input signals relating to the operation of the sales gas pipeline.

17. The system of claim 16, wherein the control system is configured to divert, using the flow diversion apparatus, at least some of the natural gas stream from the first natural gas flow path into the second natural gas flow path in response to the one or more input signals indicating a process upset in the sales gas pipeline.

18. The system of claim 16, wherein the control system is configured to introduce, using the flow introduction apparatus, a desorbed natural gas stream from the storage system into the first natural gas flow path from the third natural gas flow path in response to the one or more input signals indicating an operating regime of the sales gas pipeline that is acceptable for receiving natural gas.

19. The system of claim 18, wherein the storage system comprises an additional storage vessel having an additional one or more adsorbent beds configured to reversibly adsorb natural gas, and wherein the storage vessel is coupled to the inlet of the storage system while the additional storage vessel is coupled to the outlet of the storage system such that the storage vessel is configured to receive diverted natural gas from the second natural gas flow path and the additional storage vessel is configured to release desorbed natural gas into the third natural gas flow path.

20. The system of claim 19, comprising a heating unit communicatively coupled to the control unit and configured to heat the additional storage vessel in response to control signals from the control unit, and wherein the control unit is configured to heat the additional storage vessel to facilitate desorption of natural gas from the additional one or more adsorbent beds in response to the one or more input signals indicating the operating regime of the sales gas pipeline that is acceptable for receiving natural gas.
